(19) United States
(12) Patent Application Publication
(10) Pub. No.: US 2022/0262220 A1
(43) Pub. Date: Aug. 18, 2022

(54) AN ADVERTISING DISPLAY UNIT AND ANTI-THEFT ANTENNA PANEL

(71) Applicants: Nimesh SHAH, Cherry Hill, NJ (US); SIDEP ELECTRONICS (SHANGHAI) CO., LTD., Shanghai (CN)

(72) Inventors: Nimesh SHAH, Cherry Hill, NJ (US); Christophe Jean Dominique CASTAGNE, Shanghai (CN); Zhihao YANG, Shanghai (CN); Benjamin RUBINSTEIN, Thorofare, NJ (US); Kefeng ZENG, Thorofare, NJ (US)

(21) Appl. No.: 17/628,718

(22) PCT Filed: Jul. 21, 2020
(86) PCT No.: PCT/US2020/042914

§ 371 Date: Jan. 20, 2022

(30) Foreign Application Priority Data
Jul. 22, 2019 (CN) 201921145733.9

(51) Int. Cl. G08B 13/24; G09G 3/20; G06K 7/10

(52) U.S. Cl. CPC G08B 13/2474; G08B 13/2471; G06K 7/10316; G08B 13/248; G06K 7/10366; G09G 3/20

(57) ABSTRACT

An advertising display unit based on an anti-theft antenna includes an antenna body and an antenna panel installed on the antenna body. The antenna panel includes a front side and a reverse side. The antenna panel includes a display screen on one of the front side or reverse side. The display screen may be an LED screen or LCD screen. The display screen may be opaque or transparent.

### CROSS-REFERENCE TO RELATED APPLICATIONS

This application claims priority to Chinese Utility Model Patent No. ZL 2019 2 1145733.9 filed on Jul. 22, 2019, entitled “AN ADVERTISING DISPLAY UNIT BASED ON AN ANTI-THEFT ANTENNA TRANSPARENT PANEL,” the entirety of which is incorporated herein by reference.

### TECHNICAL FIELD

The present disclosure relates to an advertising display unit and more specifically to an advertising display unit of an electronic article surveillance reader including an antenna panel.

### BACKGROUND

Some traditional electronic article surveillance (EAS) systems include security tags or labels that can use radio frequency identification (RFID) tags or a resonant circuit with a coil and a capacitor that operate to resonate when exposed to a predetermined electromagnetic field (e.g., 8.2 MHz). RFID tags use an integrated circuit coupled to an antenna (e.g., dipole antenna, patch, ferrite antenna) or a resonant circuit and operate to emit information when exposed to a predetermined electromagnetic field (e.g., 13.56 MHz or UHF RFID, typically in the range of 860-928 MHz). A reader device is typically provided at the point of exit/entry (POE) of a business or any location where it is desired to detect the unauthorized removal of tag bearing articles. These reader devices can sound or trigger an alarm to detect and warn of the theft of store merchandise.

With developments of the advertising industry, advertisements have covered every aspect of daily life, even including antitheft readers or antennas in shopping malls. As shown in FIG. 1, a reader device 100 has a panel 2 attached to an antenna body 1. Commercial users can apply advertisements or other indicia to the panel by placing a static advertisement 3 onto the panel 2. The static advertisement can have an adhesive backing, can be fastened or clipped to the panel 2, or is otherwise physically or chemically attached to the pane. Thus, commercial users can realize an advertising function through the reader device 100. If the commercial user wishes to remove or change the advertisement, the reader device 100 is often disassembled. In other examples, the commercial user may need to scrape off adhesives, which may lead to damage to the panel. As such, commercial users may find traditional reader devices difficult to use, time consuming, and susceptible to damage.

There remains a need to provide a more efficient, effective, and dynamic EAS reader device capable of detecting EAS tags, displaying indicia or advertising, and capable of improved advertisement ability.

### SUMMARY

The following presents a summary of this disclosure to provide a basic understanding of some aspects. This summary is intended to neither identify key or critical elements nor define any limitations of embodiments or claims. Furthermore, this summary may provide a simplified overview of some aspects that may be described in greater detail in other portions of this disclosure.

Described herein is an antitheft security device comprising an antenna body comprising a reader device that operatively detects a security tag within a coverage area, an antenna panel coupled to the antenna body and comprising an antenna operatively coupled to the reader device, wherein the antenna panel further comprises a display screen, and a control panel coupled to the display screen and operatively generating instructions to control the display screen, wherein the display screen comprises at least one of a liquid crystal display screen or a light emitting diode display screen, and wherein the display screen is generally opaque or transparent. The antitheft security device may include a wireless access device communicatively coupled to the control panel. The display screen comprises a first power source and the wireless access device comprises a second power source. The wireless access device receives instructions from a wireless network and, in response, provides information to the control panel for controlling the display screen. The control panel and the wireless access device are coupled via network cable or a wireless connection. In another aspect, the antenna comprises a ferrite antenna disposed adjacent to the display screen such that the antenna does not overlap the display screen. The display screen may comprise an adhesive that operatively adheres the transparent display screen to the antenna panel or a frame/structure. The display screen may be disposed within or between one or more layers of glass, plastic, or acrylic. The antenna may comprise a radio-frequency identification ultra-high frequency antenna disposed within the antenna panel and adjacent to the display screen such that the antenna does not overlap the display screen. The display screen may be opaque liquid crystal display screen. The antenna panel may comprise a transparent antenna panel.

Also described is an antitheft security device comprising an antenna body comprising a reader device that operatively detects a security tag within a coverage area, an antenna panel coupled to the antenna body and comprising an antenna operatively coupled to the reader device, wherein the antenna panel further comprises a display screen comprising at least one of a light emitting diode display screen or a transparent liquid crystal display screen, wherein the display screen is generally transparent or opaque and a control panel coupled to the display screen, wherein the control panel comprises a processor and memory, wherein the memory stores instructions that, when executed by the processor, cause the display screen to render media content. The display screen may comprise a light emitting diode display screen, and wherein the control panel further controls the transparent light emitting diode display screen to operatively enter an off state, wherein the transparent light emitting diode display screen is generally transparent in the off state. The control panel further controls the transparent light emitting diode display screen to operatively enter an on state, wherein at least a portion of the transparent light emitting diode display screen is not transparent in the on state. The transparent light emitting diode display screen comprises an array of addressable light emitting diodes. The control panel operatively controls parameters of light emitting diodes of the array of addressable light emitting diodes to render the media content.

Also described is an antitheft security system, comprising an antenna body comprising a reader device that operatively detects a security tag within a coverage area, an antenna panel coupled to the antenna body and comprising an antenna operatively coupled to the reader device, wherein the antenna panel further comprises a display screen, and a control panel coupled to the display screen, wherein the control panel comprises a processor and memory, wherein the memory stores instructions that, when executed by the processor, cause the display screen to render media content, and wherein the display screen renders media content associated with a detected security tag. The media content may comprise a graphical representation of an item associated with an electronic product code of the detected security tag. The display screen may generate an instruction to return the item, purchase the item, or provide the item to a store employee. The control panel may instruct a camera to capture an image of when a security tag is detected.

In at least one example, in response to not detecting a security tag, the display screen renders content that is not related to the security tag, wherein the content comprises at least one of advertising media content, brand information, or news items. The display screen may iterate display of the content in a loop. The control panel may operatively modify the content based on received instructions to update the content.

Further described is an antenna body comprising a reader device that operatively detects a security tag within a coverage area; an antenna panel coupled to the antenna body and comprising an antenna operatively coupled to the reader device, wherein the antenna panel further comprises a transparent light emitting diode display screen; a control panel coupled to the transparent display screen, wherein the control panel comprises a processor and memory, wherein the memory stores instructions that, when executed by the processor, cause the transparent display screen to render media content; a wireless access device communicatively coupled to the control panel and a network; and a user device communicatively coupled to the network, wherein the user device includes a software application that operatively receives input to control operations of the transparent light emitting diode display screen. The wireless access device receives instructions from the user device in real-time or near-real-time. The control panel operatively executes the received instructions from the user device in real-time or near-real-time. The media content comprises an advertisement.

The following description and the drawings disclose various illustrative aspects. Some improvements and novel aspects may be expressly identified, while others may be apparent from the description and drawings.

### DESCRIPTION OF THE DRAWINGS

The present teachings may be better understood by reference to the following detailed description taken in connection with the following illustrations, wherein:

FIG. 1 is a perspective view of a prior art reader with an advertisement panel;

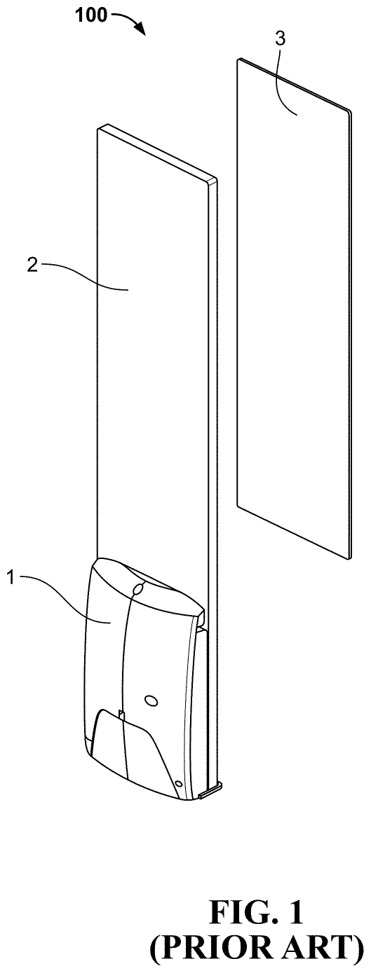

FIG. 2 is a perspective view of a reader including an antenna panel in accordance with various disclosed aspects;

FIG. 3 is an exemplary user device and interface in accordance with various disclosed aspects;

FIG. 4 is a front schematic view of a reader including an antenna panel in accordance with various disclosed aspects;

FIG. 5 is a front schematic view of the reader of FIG. 4, in accordance with various disclosed aspects; and

FIG. 6 is a perspective view of the reader of FIG. 4, in accordance with various disclosed aspects,

### DETAILED DESCRIPTION

Reference will now be made in detail to embodiments of the present teachings, examples of which are illustrated in the accompanying drawings. It is to be understood that other embodiments may be utilized and structural and functional changes may be made without departing from the scope of the present teachings. Moreover, features of the embodiments may be combined, switched, or altered without departing from the scope of the present teachings, e.g., features of each disclosed embodiment may be combined, switched, or replaced with features of the other disclosed embodiments. As such, the following description is presented by way of illustration and does not limit the various alternatives and modifications that may be made to the illustrated embodiments and still be within the spirit and scope of the present teachings.

As used herein, the words “example” and “exemplary” mean an instance, or illustration. The words “example” or “exemplary” do not indicate a key or preferred aspect or embodiment. The word “or” is intended to be inclusive rather an exclusive, unless context suggests otherwise. As an example, the phrase “A employs B or C,” includes any inclusive permutation (e.g., A employs B; A employs C; or A employs both B and C). As another matter, the articles “a” and “an” are generally intended to mean “one or more” unless context suggests otherwise.

“Logic” refers to any information and/or data that may be applied to direct the operation of a processor. Logic may be formed from instruction signals stored in a memory (e.g., a non-transitory memory). Software is one example of logic. In another aspect, logic may include hardware, alone or in combination with software. For instance, logic may include digital and/or analog hardware circuits, such as hardware circuits comprising logical gates (e.g., AND, OR, XOR, NAND, NOR, and other logical operations). Furthermore, logic may be programmed and/or include aspects of various devices and is not limited to a single device.

Moreover, terms such as “access point,” “server,” and the like, are utilized interchangeably, and refer to a network component or appliance that serves and receives control data, voice, video, sound, image, text (e.g., including chat room or help desk text, etc.) or other data-stream or signaling-stream. Data and signaling streams may be packetized or frame-based flows. Furthermore, the terms “user,” “customer,” “consumer,” and the like are employed interchangeably throughout the subject specification, unless context suggests otherwise or warrants a particular distinction among the terms. In examples, a “user” may generally refer to an end user. In another aspect, terms such as “operator,” “administrator,” “provider” and the like are employed interchangeably throughout the subject specification, unless context suggests otherwise or warrants a particular distinction among the terms. “Provider” may refer to a person (or persons) that may provide services (e.g., systems, support, etc.) to the user. It is noted that such terms may refer to human entities or automated components supported through artificial intelligence (e.g., a capacity to make inference).

It is noted that, terms “user equipment,” “device,” “user device,” “client,” and the like are utilized interchangeably in the subject application, unless context warrants particular distinction(s) among the terms. Such terms may refer to a network component(s) or appliance(s) that sends or receives data, video, sound, or substantially any data-stream or signaling-stream to or from network components and/or other devices. By way of example, a user device may comprise an electronic device capable of wirelessly sending and receiving data. A user equipment device may have a processor, a memory, a transceiver, an input, and an output. Examples of such devices include a cellular telephone (e.g., smart phone), personal digital assistant (PDA), portable computer (e.g., laptop computer), tablet computer (tablet), desktop computer, hand-held gaming counsel, wearable (e.g., smart watch), printer (e.g., copy machine, fax machine, smart printer), etc.

A network typically includes a plurality of elements that host logic. In packet-based wide-area networks (WAN), servers (e.g., devices) may be placed at different points on the network. Servers may communicate with other devices and/or databases. In an aspect, a server may provide access to a user account. The “user account” includes attributes for a particular user and commonly include a unique identifier (ID) associated with the user. The ID may be associated with a particular mobile device(s) owned by the user. The user account may also include information such as relationships with other users, application usage, location, personal settings, and other information.

Embodiments may utilize substantially any wired or wireless network. For instance, embodiments may utilize various radio access networks (RAN), e.g., Wi-Fi, global system for mobile communications, universal mobile telecommunications systems, worldwide interoperability for microwave access, enhanced general packet radio service, third generation partnership project long-term evolution (3G LTE), fourth generation long-term evolution (4G LTE), third generation partnership project 2, BLUETOOTH®, ultra mobile broadband, high speed packet access, x^{th} generation long-term evolution, or another IEEE 802.XX technology. Furthermore, embodiments may utilize wired communications.

It is noted that user equipment devices can communicate with each other and with other elements via a network, for instance, a wireless network, or a wireline network. A “network” can include broadband wide-area networks such as cellular networks, local-area networks, wireless local-area networks (e.g., Wi-Fi), and personal area networks, such as near-field communication networks including BLUETOOTH®. Communication across a network may include packet-based communications, radio and frequency/amplitude modulations networks, and the like. Communication may be enabled by hardware elements called “transceivers.” Transceivers may be configured for specific networks and a user equipment device may have any number of transceivers configured for various networks. For instance, a smart phone may include a cellular transceiver, a Wi-Fi transceiver, a BLUETOOTH® transceiver, or may be hardwired. In those embodiments in which it is hardwired, any appropriate kind or type of networking cables may be utilized. For example, USB cables, dedicated wires, coaxial cables, optical fiber cables, twisted pair cables, Ethernet, HDMI and the like.

The terms “identification tag,” “chip,” “RFID device,” and the like may be used interchangeably, unless context suggests otherwise or warrants a particular distinction among such terms. It is further noted that RFID tags may be chosen based on a frequency (e.g., low frequency RFID tags for close communication or ultra high frequency RFID tags). Identification tags may comprise printable RFID tags, NFC tags, tags including microchips, or the like. Identification tags can contain stored information, such as in a memory (e.g., read-only memory (ROM), random access memory (RAM), electrically erasable programmable read-only memory (EEPROM), or various other types of memory). In another aspect, an identification tag may be powered by electromagnetic induction from magnetic fields produced by a reader. As described herein, the identification tag may be a passive transponder that collects energy from interrogating radio waves and/or may include a local power source such as a battery. As such, an identification tag and a reader may be configured as a passive reader active tag (PRAT) system, active reader passive tag (ARPT) system, an active reader active tag (ARAT) system, or the like.

It is further noted that embodiments may utilize electronic display screens, such as transparent, semi-transparent, opaque, or see-through displays. Such displays or panels may selectively allow a user to view an image rendered on the panel, see through the panel, or see through some of the panel while an image is displayed over other parts of the panel. Such panels may include light emitting diode (LED) panels, organic light-emitting diode (OLED) panels, liquid crystal display (LCD) panels, passive transparent displays using nano-particles, or the like. While this disclosure may refer to a particular type of transparent displays (e.g., LED panels, LCD panels, OLED panels, etc.), it does so for purposes of explanation. As such, embodiments are not limited to a specific type of transparent display, unless explicitly stated so or context suggests otherwise.

In examples employing LCD panels, the display screen may comprise a plurality of twisted nematic LCDs fitted with crossed polarizers. The LCDs may modulate incoming light. Examples employing LED screens may comprise an array of addressable LEDs disposed between two or more layers of glass or other transparent material. The display may include an emissive and conductive layer. A control panel may generate electrical impulses and apply the impulses to conductive layers to produce light in the emissive layer. It is noted that the gap between pixels (e.g., individual LEDs or groups of LEDs) and the clear cathodes may enable the panel to be transparent. In some embodiments, LED screens may include an LCD layer to enable a black display.

Disclosed embodiments describe an integrated advertising display device and antitheft reader device, which may be referred to as an integrated advertisement display and antitheft reader device, an advertising display device, an antitheft reader device, or a reader device in examples. According to implementations, advertising display units of the present disclosure may include an anti-theft antenna comprising an antenna body and an antenna panel. An antenna, such as a transparent antenna panel, may be coupled to or otherwise installed on or with the antenna body. The antenna panel may comprise an electronic display screen. The electronic display screen may comprise a transparent, semi-transparent, opaque, or see-through display as described here and elsewhere in this disclosure. In an example, the antenna panel may comprise a transparent LED screen on one or more side of the transparent pane.

In another aspect, an electronic display screen may be communicatively coupled to a control panel. The control panel may include a processor and memory, which may store and execute instructions to render visual media (e.g., indicia, advertisements, greetings, etc.) on the display screen. In at least some examples, the control panel may be communicatively coupled (wired or wirelessly) to a user device. The user device may comprise an interface that allows for user interaction such that a user may upload, modify, or otherwise control the display screen. For instance, the control panel may include a wireless access device, such as a transmitter, receiver, or transceiver. The wireless device may send, receive, or send and receive communications from other devices through direct communication or via an access point. It is noted that the display screen, wireless access device, control panel, and anti-theft antenna may be powered by one or more power sources. In an example, the display screen and control panel may be powered by a first power source and the wireless access device may be powered by a second power source.

Embodiments described herein may resolve long felt needs in this field. For instance, the antenna panel may become partially clear, opaque, colored, tinted, or the like when in response to instructions from the control panel, such as when displaying an advertisement. The antenna panel may then become clear or see-through when not displaying the advertisement. In other examples, the media rendered via the antenna panel may be altered without a user physically contacting the antenna panel. In traditional systems, advertisement is static and must be physically changed by a user. Moreover, to become transparent, the traditional static advertisement must be removed and the panel may often need to be washed or cleaned to remove chemical residue or portions of an adhesive backed advertisement that may not have peeled off.

Antenna panels disclosed herein may maintain its transparency when a display screen is in an “off” state or is otherwise instructed to be transparent. In an “on” state or otherwise instructed, a control panel may instruct the display screen to render static images, dynamic images (e.g., moving images, videos, etc.) or the like. Such displays may enrich the choice of users and may eliminate the need for assembling and reassembling some or all of an integrated advertising display device and antitheft reader device when replacing the advertising contents. It is further noted that embodiments may provide improved functionality, higher reliability, practicality, and aesthetics than traditional systems.

In at least one embodiment, an integrated advertising display device and antitheft reader device includes an antenna body and an antenna panel installed on or coupled with the antenna body. The antenna panel may include a transparent LED screen on its front or reverse side. The transparent LED screen may be adhered to the antenna panel, disposed within the panel, or the like. The transparent LED screen may be communicatively coupled or connected to a control panel and wireless access device. The transparent LED screen may be powered by a first power source, while the wireless access device is powered by a second power source. The wireless access device and the control panel may be communicatively coupled via network cable or a wireless connection. The wireless access device may be communicatively coupled to or include a user device, such as an intelligent unit (e.g., smart device). The user device may control the display contents of the transparent LED screen through an application running on a user device (e.g., smartphone, tablet computer, computer, PDA, etc.).

It is noted that embodiments described herein may provide many advantages that will be apparent or explicitly described herein. For example, embodiments may allow for real-time or near-real-time display and real-time or near-real-time replacement of advertising contents, eliminating the need for assembling and reassembling when replacing the advertising contents. Embodiments may further boast higher reliability and practicality.

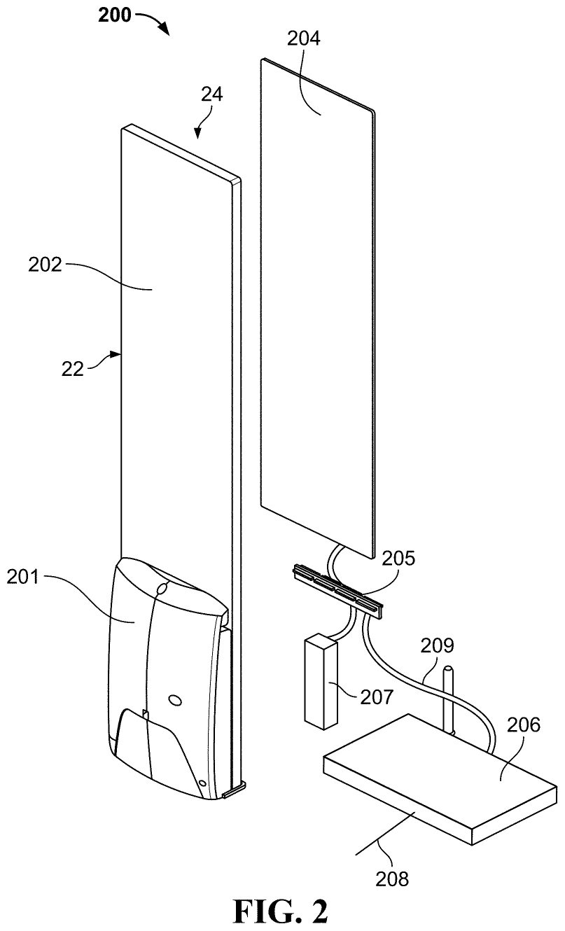

Turning now to FIG. 2, there is an integrated advertising display device and antitheft reader device 200. The device 200 primarily includes an antenna body 201 and the antenna panel 202, where the antenna panel 202 may be installed on or coupled to a frame of the antenna body 201 while an antenna of the antenna panel 202 is not overlapped with the antenna body 201. The antenna body 201 and antenna panel 202 may comprise a pedestal placed in a retail store.

In some examples, the pedestal may be utilized with one or more other pedestal, a gate, or the like. For instance, the device 200 may include a plurality of antenna bodies, antenna panels, displays or the like. Generally, pairs of pedestals may be placed at entry or exit points, point of sale, or other location of a retail store. Other embodiments may utilize pedestals placed in open air spaces (e.g., mall kiosks, markets, etc.). It is noted that the pedestal shown in the figure is illustrated as an example and embodiments are not limited to those shown. The term “pedestal” includes security tag detectors that can be positioned under floors, in overhead locations, entrances/exits of stores or at checkout counters, etc.

Such pedestals may detect a security tag in a defined coverage area and may provide tag interrogation and detection operations through an antenna that interacts with the security tag. It is noted that the pedestal may include or communicate with an alarm to alert a retail store employee of an article's unauthorized removal or attempted removal from the retail premises. It is noted that operative components of the pedestal may be housed within the antenna body 201. For instance, a transponder circuit (e.g., one or more receivers, transmitters, or transponders for communicating with wireless devices), power circuit (for receiving power from a power source), processor and memory, and other electronic components may be disposed within the antenna body 201. The antenna body 201 may additionally or alternatively include people counters, metal detectors, motion detectors, audio devices (e.g., speakers), or the like.

In an aspect, the antenna panel 202 may comprise glass (e.g., silica-based glass, poly(methyl methacrylate) glass, or the like), plastic, acrylic, or the like. In some embodiments, the antenna panel 202 may comprise a solid frame with openings or apertures formed therethrough. Moreover, the antenna panel 202 may include one or more sensors, antennas, or the like for detecting an EAS tag passing through a coverage area, detecting motion, or the like.

The antenna panel 202 may include an electronic transparent display screen 204 on a front (e.g., first) side 222 or on a reverse (e.g., second) side 224. While depicted as a board-shaped rectangular prism (e.g., with two dominant sides and a relatively long and thin shape), it is noted that the antenna panel 202 may include other or different sides. For instance, the antenna panel 202 may be a triangular prism, rectangular prism, or the like. As such, the transparent display screen 204 may be disposed on different sides, within or internal to sides, or the like. For example, the transparent display screen 204 may be located in between the two layers of the antenna panel 202.

The transparent display screen 204 may comprise a see-through LED panel or other panel as described herein. The transparent display screen 204 may be integral to the antenna panel 202 or may be attached to or disposed on the antenna panel 202. For instance, the transparent display screen 204 may include one or more antennas, LEDs, or twisted nematic LCDs fitted with crossed polarizers all embedded within or overlayed between layers of a translucent material (e.g., glass). In another aspect, the transparent display screen 204 may be adhered (e.g., with a chemical composition, via welding, etc.), mechanically fastened to (e.g., screwed, bolted, clamped, etc.), or otherwise coupled to the antenna panel 202. As an example, the transparent display screen 204 may comprise a commercially LED display screen such as a P6.5 or P6 SERIES™ adhesive display screen manufactured by TIEGE TECHNOLOGY™.

It is further noted that the transparent display screen 204 may comprise a power cable 207 for connecting the transparent display screen 204 to a power source, such as a batter or power mains. In some embodiments, the display screen 204 may be coupled to a power source or power cable of the antenna body 201. The power source may provide power, via the power cable 207, to a control panel 205 of the transparent display screen 204.

The control panel 205 may comprise or communicate with a light or display driver that selectively illuminates pixels of the transparent display screen 204. As an illustrative embodiment, the transparent display screen 204 may comprise an LED display screen comprising addressable LEDs arranged in an array. The control panel 205 may comprise a processor that executes instructions stored in a memory device. The processor generates instructions to selectively supply power to LEDs in the array of LEDs and selectively control characteristics of the LEDs, such as brightness, color or hue, and the like. In an aspect, the control panel 205 may control the array of LEDs to render media, such as indicia, static advertisements (e.g., non-moving pictures, text, etc.), video or moving images, and the like. As described herein, a user may select or control the rendered media through a user device interacting with the control panel 205.

As described herein and elsewhere in this disclosure, other display types may be utilized such as transparent LCDs, opaque LCDs, or opaque LEDs. As an example, the control panel further controls the transparent light emitting diode display screen or other screen to operatively enter an off state, wherein the transparent light emitting diode display screen or other screen is generally transparent or opaque in the off state. The control panel further controls the transparent light emitting diode display screen or other screen to operatively enter an on state, wherein at least a portion of the transparent light emitting diode display screen or other screen is not transparent or not opaque in the on state. In an example, a transparent or opaque light emitting diode display screen comprises an array of addressable light emitting diodes. The control panel operatively controls parameters of light emitting diodes of the array of addressable light emitting diodes to render the media content. In examples utilizing an opaque or transparent LCD screen, a twisted nematic liquid crystal display includes crossed polarizers, wherein the controller applies voltage to pixels of the liquid crystal display to modulate incoming light, wherein white pixels may be opaque or transparent. In some examples, described opaque or transparent LCD screens may not include a diffuser layer as in non-transparent or non-opaque LCD screens. Additionally, opaque or transparent LCD screens may include lineral polarizing filters configured to absorb about half of the incoming unpolarized light.

It is noted that the control panel 205 may be configured to render preprogrammed media, render uploadable media, or the like. For instance, the control panel 205 may include or be coupled (via a wired connection 209 or a wireless connection) with a wireless access device 206, such as a transceiver, router, or the like. In an example, the wireless access device may comprise a synchronous LED sender device which may comprise one or more sending cards. The sending card may comprise circuitry to convert input video via a wireless or wired signal (HDMI/DVI) to a format that control panel 205 may utilize to render the media via the transparent display screen 204. While described as a wireless access device 206, it is noted that the wireless access device may include hardwiring capabilities, wireless capabilities, or both. In an example, the wireless access device 206 and the control panel 205 may comprise commercially available devices. For instance, wireless access device 206 may comprise an LED sender box manufactured by NOVASTAR™, such as the NOVASTAR MCTRL300™ or NOVASTAR MCTRL 1660™ synchronous LED sender box, and the control panel 205 may comprise a control panel manufactured by NOVASTAR™, such as the NOVASTAR A4S or NOVASTAR MRV328 LED control panels. It is noted that, while depicted as separate components, the control panel 205 and the wireless access device 206 may be comprised by a single device, may be disposed within the antenna body 201, or the like. Moreover, while control panel 205 is shown coupled to a power supply via the power cable 207 and the wireless access device 206 is shown as coupled to a power supply via power cable 208, the control panel 205 and the wireless access device 206 may include or be coupled with a common power cable or power source.

The wireless access device 206 may be communicatively coupled to a user device, such as wirelessly to a smartphone or the like. In an example, the wireless access device 206 may communicate directly with a user device (e.g., such as through Wi-Fi Direct, BLUETOOTH, etc.) or may be coupled to a network (e.g., a Wi-Fi network, the Internet, cellular networks, etc.). The user device may upload, stream, or otherwise provide media content to the wireless access device 206. The wireless access device 206 may communicate the media content to the control panel 205. The control panel 205 may control the transparent display screen 204 (e.g., such as one or more LEDs of an array of LEDs) to display the media content.

In at least some embodiments the transparent display screen 204 may include touch foils or the like that may allow a user to provide touch input to the transparent display screen 204. This may allow for interactive experiences, ability to modify media content, or the like. In other examples, the control panel 205 may include or interact with sensors (e.g., motion sensors, image sensors, audio sensors, etc.). The control panel 205 may update displayed media content or trigger display of particular media content based on input provided by the sensors. For instance, the control panel 205 may place the transparent display screen 204 in a sleep or power saving mode after a period of inactivity (e.g., no users entering or exiting with a predetermined amount of time), and may exit the sleep mode upon a sensor identifying motion, a sound, or the like. As another example, image sensors may utilize image recognition to identify logos or brands on customers and may target advertisement to the customers.

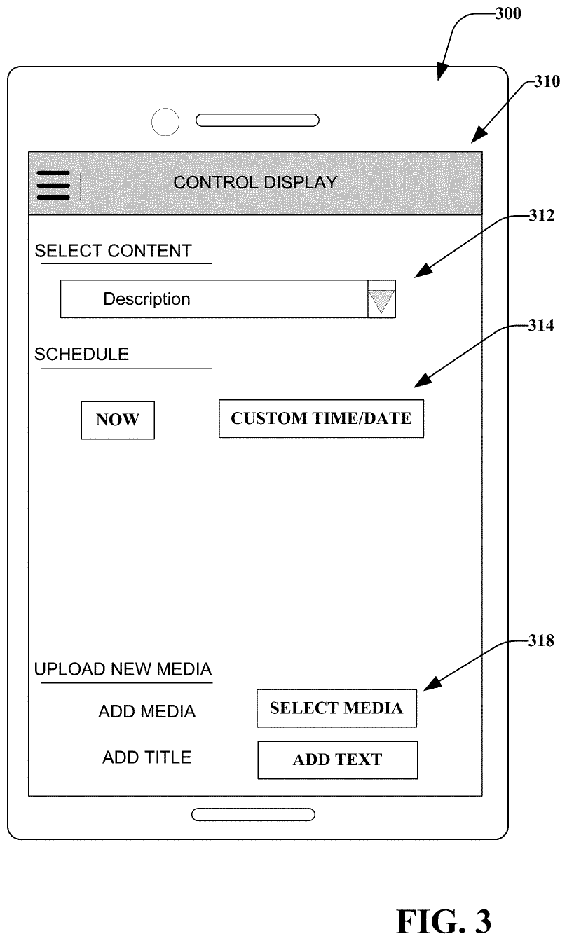

Turning to FIG. 3, there is an exemplary user device 300 comprising an interface that may be employed to execute various disclosed embodiments. It is noted that various components may be implemented in combination with computer executable instructions, hardware devices, and/or combinations of hardware and software devices that may be performed by user device 300.

User device 300 may include various components, hardware devices, software, software in execution, and the like. In embodiments, user device 300 may include smart phones, tablet computers, PDA's, laptop or desktop computers, or other devices as described here and elsewhere. The user device 300 generally includes a processing unit(s) memory device(s), wireless or wired controllers, and other components. As described herein, the memory may store instructions (e.g., software applications or “apps”) that may be executed by the processor.

As described herein, a processor may comprise various hardware processing devices, such as single-core or multi-core processing devices. Moreover, processing unit(s) may refer to a “processor,” “controller,” “computing processing unit (CPU),” or the like. Such terms generally relate to a hardware device. Additionally, a processing unit may include an integrated circuit, an application-specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or the like.

The user device 300 may include one or more input/output (“IO”) device(s) 310. The input device 310 may comprise user interface devices or other input devices, such as sensors (e.g., microphones, pressure sensors, light sensors, etc.), keyboard, mouse (e.g., pointing device), joystick, remote controller, gaming controller, touch screen, stylus, and the like.

In an example, an I/O device 310 may comprise a touch screen. The touch screen may render or display information of an application. For instance, the screen may display user controls may include a content selection control 312 to allow a user to select media content for uploading to or rendering by a transparent display screen. In another aspect, the user controls may include a schedule control 314 that may allow a user to specify when media content should be displayed (e.g., immediately, based on a triggering event such as a time/place, detection of a user, detection of a security tag, etc.). In at least one embodiment, the user controls may include an upload control 318 that may upload media content and an identification of the media content to a server or the wireless access device 206.

It is noted that the user device 300 may include a login or security feature that interacts with the wireless access device 206, a server, or other device to allow or prevent the user device 300 from modifying parameters for display by the transparent display screen 204. For example, embodiments may only allow administrative level users to access, store, create, or otherwise control content to be displayed.

In an example, the user device 300 may comprise a user device of a system level administrator who may set or program media content for display across multiple stores (e.g., franchised stores, stores in a particular geographic location such as a shopping mall) or the like. The administrator may set the media content to be rendered and may upload instructions via a network (e.g., such as the internet, cellular networks, etc.) to control multiple transparent display screens.

According to embodiments disclosed herein, transparent display screens may be used to realize the real-time display and real-time replacement of advertising content, eliminating the need for antenna disassembly and assembly when replacing the advertising content.

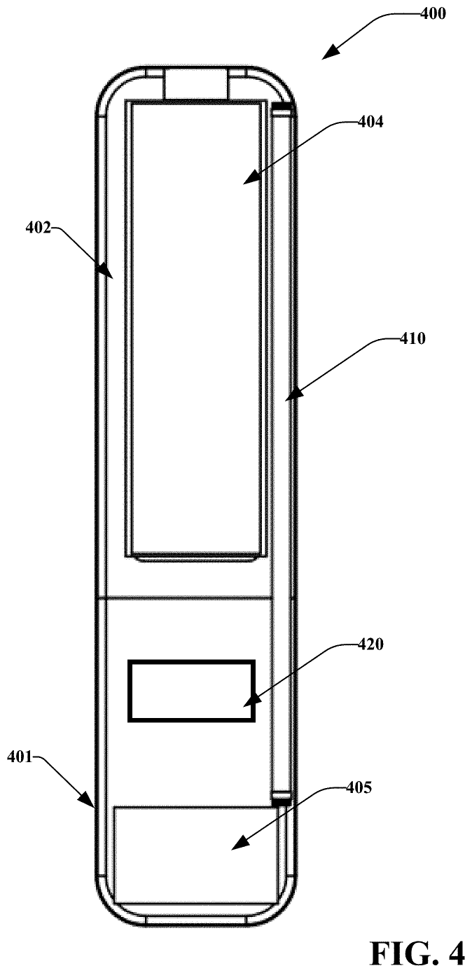

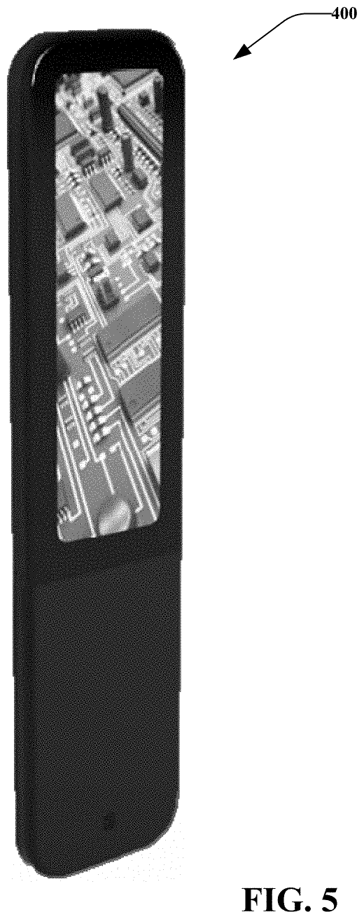

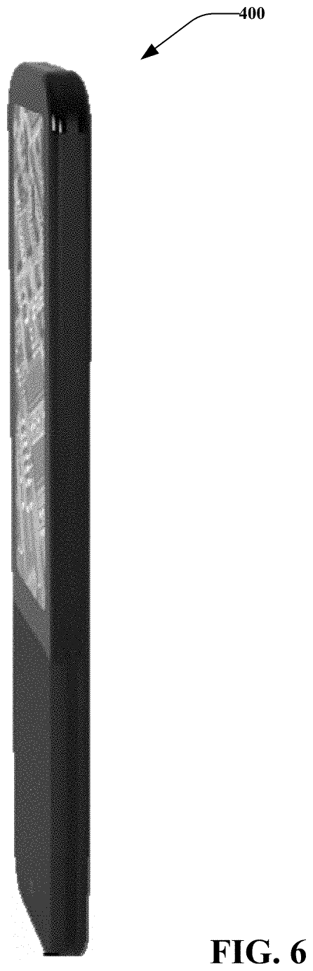

Turning now to FIGS. 4-6, there are views of an integrated advertising display device and antitheft reader device 400. The device 400 primarily includes an antenna body 401 and the antenna panel 402 installed on or coupled to the antenna body 201. The antenna body 401 and antenna panel 402 may comprise a pedestal placed in a retail store. In at least one example, the antenna body 401 and antenna panel 402 may be integrally formed, such as comprising a common frame or housing.

It is noted that the device 400 may include similar aspects as described with reference to device 200. For instance device 200 may comprise a pedestal that may be utilized with one or more other pedestal, a gate, or the like disposed at or placed at entry or exit points, point of sale, positioned under floors, in overhead locations, entrances/exits of stores or at checkout counters, etc.

In an aspect, the antenna panel 202 may comprise glass, plastic, or the like. In some embodiments, the antenna panel 202 may comprise a solid frame with openings or apertures formed therethrough. Moreover, the antenna panel 202 may include one or more sensors, antennas, or the like for detecting an EAS tag passing through a coverage area, detecting motion, or the like.

The antenna panel 402 may include an electronic display screen 404 on a front (e.g., first) side or on a reverse (e.g., second) side (not shown). While depicted as a board-shaped rectangular prism (e.g., with two dominant sides and a relatively long and thin shape), it is noted that the antenna panel 402 may include other or different sides as described herein. The display screen 404 may comprise a see-through LED display screen, opaque LED display screens, a twisted nematic LCD screens fitted with crossed polarizers all embedded within or overlayed between layers of a translucent material (e.g., glass). In an example, the display screen 404 may be mounted behind a thermoformed acrylic panel with having a rear comprising a non-translucent color, such as black, blue, or the like. In an example, the rear may be painted black, include a black overlay, or the like.

In at least one embodiment, the antenna panel 402 may include one or more antennas, such as an RF EAS antenna 410 comprising a ferrite antenna. A ferrite antenna may comprise a rod or bar made of ferrite. As an example, the ferrite antennal may comprise a ferrite core, a coil, and a capacitor. The coil may be wrapped around the core and connected to the capacitor to form a resonant circuit. The coil may be formed of angled traces wrapped around the core to form turns of the coil, and each angled trace may be electrically and physically connected in series to an adjacent angled trace to form a helical structure of the coil. The ferrite coil antenna may allow for placement adjacent (e.g., proximal, close to or abutting in physical contact with) metal objects, such as a frame of the antenna panel 402 or metal portions of the display screen 404 without impacting performance of the detection of EAS labels.

The RF EAS antenna 410 may be disposed within a housing of the device 400, such as disposed within the housing of the antenna panel 402. It is noted that the RF EAS antenna 410 does not overlap the display screen 404. For instance, as viewed from a major side of the device 400, the display screen 404 may be viewable and may be planar and the RF EAS antenna 410 is not behind or in front of the display screen 404 as viewed from the major side. The RF EAS antenna 410 may be located adjacent to or on the side of the display screen 404. In some examples, as the RF EAS antenna 410 may comprise a ferrite antenna, the ferrite antenna may be generally small in size relative loop antennas or other traditional antennas. This may allow the ferrite antenna to be disposed within the housing of the antenna panel 402 and in an area that may represent a bevel of the display screen 404. In examples, the antenna panel 402 may be not substantially larger than the display.

Additionally or alternatively, device 400 may comprise an RFID ultra high frequency (UHF) antenna 420. In an example, the RFID UHF 420 may comprise a UHF patch antenna that may be utilized for embodiments comprising a display screen 404 that includes an RFID LED or LCD display screen. In examples, the RFID UHF antenna 420 may be disposed be behind the display screen 404, adjacent to the display screen 404, or in another desired locations.

It is further noted that the transparent display screen 404 may be communicatively coupled to a control panel 405, power source, power cable, and other circuitry. The power source may provide power to the display screen 404.

The control panel 405 may comprise or communicate with a light or display driver that selectively illuminates pixels of the display screen 404. As an illustrative embodiment, the display screen 404 may comprise an opaque LED display screen comprising addressable LEDs arranged in an array, an opaque LCD screen, or a transparent LED or LCD screen. The control panel 405 may comprise a processor that executes instructions stored in a memory device. The processor generates instructions to selectively supply power to LEDs in the array of LEDs, control pixels of an LCD screen, and selectively control characteristics, such as brightness, color or hue, and the like. In an aspect, the control panel 405 may control the display screen 404 to render media, such as indicia, static advertisements (e.g., non-moving pictures, text, etc.), video or moving images, and the like. As described herein, a user may select or control the rendered media through a user device interacting with the control panel 405. In other embodiments, the media displayed by the display screen 404 may be preprogramed or controlled by a central server.

According to at least one embodiment, the RF EAS antenna 410 may detect an electronic tag in a coverage area of the RF EAS antenna 410. The tag may be, for instance, attached to an article. The RF EAS antenna 410 may induce and receive a response from the tag. The RF EAS antenna 410 may then communicate identification information from the tag to the control panel 405. The control panel 405 may trigger a desired action if the tag is associated with an article that has not been purchased, such as generating an alarm, sending an alert to another device, or the like.

In another example, the control panel 405 may identify an electronic product code (EPC) received from the tag and may identify an item associated with the EPC. It is noted that the control panel 405 may identify the item based on information stored within a local memory or a remote memory. The control panel 405 may identify information associated with the item, such as an image, video, alphanumerical description, or the like. The control panel 405 may then instruct the display screen 404 to render information associated with the item. Additionally or alternatively, the control panel 405 may generate instructions for a consumer, such as audio or visual instructions to return or purchase an item, provide the item to an employee of a store, or the like.

According to at least one example, the control panel 405 may instruct the display screen 404 to render information not related to a detected EPC. For instance, the control panel 405 may render content when a security tag is not detected or has not been detected for a period of time. In such instances, the display screen 404 may render content that is not related to the security tag, wherein the content comprises at least one of advertising media content, brand information, news items, time/date information, calendar of events, etc. The control panel 405 may instructed the display 404 to iterate the display of the content in a loop. The time period associated with the loop may be based on the length of the content to be displayed. The loop may comprise an ordered display of content or a randomized or semi-randomized order. For instance, the loop may consist of display first content, second content, and third content in that order. In other examples, the loop may randomly or semi-randomly display the first, second, and third content in different orders, or may select other content (e.g., forth, five, etc. content) or display in any order. Additionally or alternatively, the control panel 405 may operatively modify the content based on received instructions to update the content. For instance, a server may send an update to the control panel 405. The update may comprise new content (e.g., updated news, new advertising, etc.). The server may push an update based on a predetermined schedule or on a triggering event (e.g., braking news, user command, etc.)

In at least some embodiments, the control panel 405 may instruct a camera (e.g., of the device 400 or a remote camera) to capture imagery of the consumer when a tag is detected in addition to as an alternative to displaying information, generating, an alarm, or instructing a user to perform an action.

What has been described above includes examples of the present specification. It is, of course, not possible to describe every conceivable combination of components or methodologies for purposes of describing the present specification, but one of ordinary skill in the art may recognize that many further combinations and permutations of the present specification are possible. Each of the components described above may be combined or added together in any permutation to define embodiments disclosed herein. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

The structure, scale, and size presented in the drawings of this document are used for illustrating the contents disclosed herein and facilitating understanding and reading by persons familiar with this technology, rather than limiting the conditions for the implementation of this utility model. They are of no technical significance, and any structural modification, scale change, or size adjustment shall be covered by the technical contents disclosed herein as long as they do not affect the functions and purposes of this utility model. Meanwhile, such expressions as “above”, “below”, “left”, “right”, and “center” used in this document are for facilitating the illustration only, rather than limiting the implementation scope of this utility model. Changes or adjustments in the relative relationship is within the implementation scope of disclosed embodiments as long as there are no substantial changes to the technical contents.

What is claimed is:

1. An antitheft security device comprising:
an antenna body comprising a reader device that operatively detects a security tag within a coverage area;
an antenna panel coupled to the antenna body and comprising an antenna operatively coupled to the reader device, wherein the antenna panel further comprises a display screen; and
a control panel coupled to the display screen and operatively generating instructions to control the display screen, wherein the display screen comprises at least one of a liquid crystal display screen or a light emitting diode display screen, and wherein the display screen is generally opaque or transparent.

2. The antitheft security device of claim 1, further comprising a wireless access device communicatively coupled to the control panel.

3. The antitheft security device of claim 2, wherein the display screen comprises a first power source and the wireless access device comprises a second power source.

4. The antitheft security device of claim 2, wherein the wireless access device receives instructions from a wireless network and, in response, provides information to the control panel for controlling the display screen.

5. The antitheft security device of claim 2, wherein the control panel and the wireless access device are coupled via network cable or a wireless connection.

6. The antitheft security device of claim 1, wherein the antenna comprises a ferrite antenna disposed adjacent to the display screen such that the antenna does not overlap the display screen.

7. The antitheft security device of claim 1, wherein the display screen comprises an adhesive that operatively adheres the transparent display screen to the antenna panel or a frame/structure.

8. The antitheft security device of claim 1, wherein the display screen is disposed within or between one or more layers of glass, plastic, or acrylic.

9. The antitheft security device of claim 1 wherein the antenna comprises a radio-frequency identification ultra-high frequency antenna disposed within the antenna panel and adjacent to the display screen such that the antenna does not overlap the display screen.

10. The antitheft security device of claim 1, wherein the display panel is an opaque liquid crystal display screen.

11. The antitheft security device of claim 1, wherein the antenna panel comprises a transparent antenna panel.

12. An antitheft security device comprising:
an antenna body comprising a reader device that operatively detects a security tag within a coverage area;
an antenna panel coupled to the antenna body and comprising an antenna operatively coupled to the reader device, wherein the antenna panel further comprises a display screen comprising at least one of a light emitting diode display screen or a transparent liquid crystal display screen, wherein the display screen is generally transparent or opaque; and
a control panel coupled to the display screen, wherein the control panel comprises a processor and memory, wherein the memory stores instructions that, when executed by the processor, cause the display screen to render media content.

13. The antitheft security device of claim 12, wherein the display screen comprises the light emitting diode display screen, and wherein the control panel further controls the transparent light emitting diode display screen to operatively enter an off state, wherein the transparent light emitting diode display screen is generally transparent in the off state.

14. The antitheft security device of claim 13, wherein the control panel further controls the transparent light emitting diode display screen to operatively enter an on state, wherein at least a portion of the transparent light emitting diode display screen is not transparent in the on state.

15. The antitheft security device of claim 13, wherein the transparent light emitting diode display screen comprises an array of addressable light emitting diodes.

16. The antitheft security device of claim 15, wherein the control panel operatively controls parameters of light emitting diodes of the array of addressable light emitting diodes to render the media content.

17. An antitheft security system, comprising:
an antenna body comprising a reader device that operatively detects a security tag within a coverage area;
an antenna panel coupled to the antenna body and comprising an antenna operatively coupled to the reader device, wherein the antenna panel further comprises a display screen; and
a control panel coupled to the display screen, wherein the control panel comprises a processor and memory, wherein the memory stores instructions that, when executed by the processor, cause the display screen to render media content, and wherein the display screen renders media content associated with a detected security tag.

18. The antitheft security system of claim 17, wherein the media content comprises a graphical representation of an item associated with an electronic product code of the detected security tag.

19. The antitheft security system of claim 18, wherein the display screen generates an instruction to return the item, purchase the item, or provide the item to a store employee.

20. The antitheft security system of claim 17, wherein the control panel instructs a camera to capture an image of when a security tag is detected.

21. The antitheft security system of claim 17, wherein, in response to not detecting a security tag, the display screen renders content that is not related to the security tag, wherein the content comprises at least one of advertising media content, brand information, news items, events, or date and time information.

22. The antitheft security system of claim 21, wherein the display screen iterates display of the content in a loop.

23. The antitheft security system of claim 21, wherein the control panel operatively modifies the content based on received instructions to update the content.
